(19) United States
(12) Patent Application Publication
(10) Pub. No.: US 2015/0073867 A1
(43) Pub. Date: Mar. 12, 2015

(54) Systems and Methods for Predicting User Lifetime Value Using Cohorts

(71) Applicant: Upsight, Inc., San Francisco, CA (US)

(72) Inventors: Martin Colaco, San Mateo, CA (US); Josh Williams, San Francisco, CA (US); Ofer Shai, Toronto (CA); Kris Coward, Toronto (CA); Nathan Triplett, San Francisco, CA (US)

(73) Assignee: Upsight, Inc.

(21) Appl. No.: 14/482,951

(22) Filed: Sep. 10, 2014

Related U.S. Application Data
(60) Provisional application No. 61/877,026, filed on Sep. 12, 2013.

(51) Int. Cl. G06Q 30/02

(52) U.S. Cl. CPC G06Q 30/0202; G06Q 30/0201
USPC 705/7.31

(57) ABSTRACT

Systems and methods for predicting user lifetime value in accordance with embodiments of the invention are disclosed. In one embodiment, a lifetime value prediction server system includes a processor, and a memory configured to store a lifetime value prediction application, wherein the lifetime value prediction application directs the processor to obtain a set of user interaction data, group the set of user interaction data into cohorts, where the user interaction data within a cohort occurs on a particular day, calculate a set of known spending values based on the cohorts, determine a set of predicted spending values based on the set of known spending values, determine a set of predicted spending confidence values based on the set of known spending values, and calculate a set of predicted lifetime value data based on the set of predicted spending values and the set of predicted spending confidence values.

### CROSS-REFERENCE TO RELATED APPLICATIONS

The current application claims priority to U.S. Provisional Patent Application Ser. No. 61/877,026, filed Sep. 12, 2013, the disclosure of which is hereby incorporated by reference in its entirety.

### FIELD OF THE INVENTION

The present invention is generally related to analyzing user interactions with software applications and more specifically to the prediction of lifetime value for users of software applications based on user interaction data.

### BACKGROUND

A customer is a person (or other entity) that receives a good or service in exchange for consideration, such as money. User lifetime value (LTV) is the present value of the future value flows attributed to the relationship with the customer. These values must be quantifiable and often are monetary in nature. As the completion of a user's lifetime in a software application is uncertain, a time limitation is often specified when calculating LTV (e.g. 90-day LTV is the LTV for users in the 90-days after some specified activity, such as installing the application for the first time).

### SUMMARY OF THE INVENTION

Systems and methods for predicting user lifetime value in accordance with embodiments of the invention are disclosed. In one embodiment, a lifetime value prediction server system includes a processor, and a memory configured to store a lifetime value prediction application, wherein the lifetime value prediction application directs the processor to obtain a set of user interaction data including interaction data describing interactions with a target application, timestamp data describing when the interactions occurred, and value data associated with a user interaction with the target application for users having the same installation date and a measure of the number of days since the installation of the target application, group the set of user interaction data into cohorts, where the user interaction data within a cohort occurs on a particular day, calculate a set of known spending values based on the cohorts, where the set of known spending values includes a total spending value for the cohort for the usage data for each day having aggregated user interaction data within the cohort, determine a set of predicted spending values based on the set of known spending values, where the size of the set of predicted spending values is based on a desired number of days since the installation of the target application, determine a set of predicted spending confidence values for each predicted spending value in the set of predicted spending values based on the set of known spending values, and calculate a set of predicted lifetime value data based on the set of predicted spending values and the set of predicted spending confidence values.

In another embodiment of the invention, the cohorts are aligned based on the installation of the target application.

In an additional embodiment of the invention, the set of predicted spending values is determined on days when each cohort has user interaction data for those days.

In yet another additional embodiment of the invention, the set of predicted spending values is determined on days when a portion of the cohorts has user interaction data for those days.

In still another additional embodiment of the invention, the cohorts are aligned based on a set of days.

In yet still another additional embodiment of the invention, the lifetime value prediction application further directs the processor to obtain historical user interaction data including historical interaction data describing interactions with a target application, historical timestamp data describing when the interactions occurred, and historical value data associated with a user interaction with the target application for users having the same installation date and a measure of the number of days since the installation of the target application, and calculate a set of predicted lifetime value data based on the set of predicted spending values, the set of predicted spending confidence values, and the historical user interaction data.

In yet another embodiment of the invention, the lifetime value prediction application further directs the processor to group the historical user interaction data into historical cohorts, and combine the historical cohorts with the cohorts.

In still another embodiment of the invention, the predicted spending confidence values are based on a threshold confidence interval.

In yet still another embodiment of the invention, the threshold confidence interval is pre-determined.

In yet another additional embodiment of the invention, confidence interval is determined by generating a number of statistical distributions with the appropriate statistical distribution and iteratively determining the confidence level using the generated distributions.

In still another additional embodiment of the invention, the cohorts are selected based on the value data of the user interaction data within the cohorts.

In yet still another additional embodiment of the invention, the lifetime value prediction application further directs the processor to filter the user interaction data and group the set of user interaction data into cohorts using the filtered user interaction data.

In yet another embodiment of the invention, the user interaction data is filtered based on the timestamp data.

In still another embodiment of the invention, the user interaction data is filtered based on the value data.

In yet still another embodiment of the invention, the value data includes monetary spending within the target application

In yet another additional embodiment of the invention, value data includes online social networking messages obtained by the target application.

In still another additional embodiment of the invention, the value data includes interactions with advertising data displayed within the target application.

In yet still another additional embodiment of the invention, the lifetime value prediction application further directs the processor to obtain additional user interaction data, group user interaction data into cohorts including the additional user interaction data, compute updated known spending values based on the cohorts and the additional user interaction data, and refine the calculated set of predicted lifetime value data based on the updated known spending values.

In yet another embodiment of the invention, the lifetime value prediction application further directs the processor to measure performance of the calculated predicted lifetime value data based on the updated known spending values.

Still another embodiment of the invention includes a method for predicting user lifetime value data, including obtaining a set of user interaction data using a lifetime value prediction server system, the user interaction data including interaction data describing interactions with a target application, timestamp data describing when the interactions occurred, and value data associated with a user interaction with the target application for users having the same installation date and a measure of the number of days since the installation of the target application, grouping the set of user interaction data into cohorts using the lifetime value prediction server system, where the user interaction data within a cohort occurs on a particular day, calculating a set of known spending values based on the cohorts using the lifetime value prediction server system, where the set of known spending values includes a total spending value for the cohort for the usage data for each day having aggregated user interaction data within the cohort, determining a set of predicted spending values based on the set of known spending values using the lifetime value prediction server system, where the size of the set of predicted spending values is based on a desired number of days since the installation of the target application, determining a set of predicted spending confidence values for each predicted spending value in the set of predicted spending values based on the set of known spending values using the lifetime value prediction server system, and calculating a set of predicted lifetime value data based on the set of predicted spending values and the set of predicted spending confidence values using the lifetime value prediction server system.

Yet another embodiment of the invention includes a non-transitory machine readable medium containing processor instructions, where execution of the instructions by a processor causes the processor to perform a process including obtaining a set of user interaction data, the user interaction data including interaction data describing interactions with a target application, timestamp data describing when the interactions occurred, and value data associated with a user interaction with the target application for users having the same installation date and a measure of the number of days since the installation of the target application, grouping the set of user interaction data into cohorts, where the user interaction data within a cohort occurs on a particular day, calculating a set of known spending values based on the cohorts, where the set of known spending values includes a total spending value for the cohort for the usage data for each day having aggregated user interaction data within the cohort, determining a set of predicted spending values based on the set of known spending values, where the size of the set of predicted spending values is based on a desired number of days since the installation of the target application, determining a set of predicted spending confidence values for each predicted spending value in the set of predicted spending values based on the set of known spending values, and calculating a set of predicted lifetime value data based on the set of predicted spending values and the set of predicted spending confidence values.

### BRIEF DESCRIPTION OF THE DRAWINGS

FIG. 1 conceptually illustrates a lifetime value prediction system in accordance with an embodiment of the invention.

FIG. 2 conceptually illustrates a lifetime value prediction server system in accordance with an embodiment of the invention.

FIG. 3 is a flow chart conceptually illustrating a process for generating cohorts in accordance with an embodiment of the invention.

FIG. 4 is a flow chart conceptually illustrating a process for predicting lifetime value data in accordance with an embodiment of the invention.

FIG. 5 is a flow chart conceptually illustrating a process for back-testing and refining predicted lifetime value data in accordance with an embodiment of the invention.

FIGS. 6A and 6B are exemplary screenshots of a user interface for displaying predicted lifetime value data in accordance with an embodiment of the invention.

FIG. 7 is a flow chart conceptually illustrating a process for augmenting cohort data in accordance with an embodiment of the invention.

FIG. 8A is a conceptual illustration of historical cohort behavior in accordance with an embodiment of the invention.

FIGS. 8B and 8C are conceptual illustrations of predicted cohort behavior in accordance with embodiments of the invention.

### DETAILED DESCRIPTION

Turning now to the drawings, systems and methods for predicting user lifetime value in accordance with embodiments of the invention are disclosed. Many applications, including those obtained from an application marketplace such as the Google Play service provided by Google, Inc. of Mountain View, Calif. or the App Store service provided by Apple, Inc. of Cupertino, Calif., generate value based on actions performed by a user within the application. These user interactions include, but are not limited to, micro-transactions (e.g. providing features of the application in exchange for a monetary fee), advertising impressions (e.g. advertising views, advertising click-through, etc. . . . ), and/or online social networking actions (e.g. posting social networking messages, providing referrals to non-users of the application, etc. . . . ) as appropriate to the requirements of specific applications. The value associated with a user interaction can be defined using a value metric; the value metric can be measured directly using a monetary value and/or indirectly via a points (or other abstract) value. In several embodiments, the value metric is based on revenue generated by the user interactions. In a variety of embodiments, the value metric is measured indirectly based on revenues generated as a result of the referral of users to the application as a result of the online social networking actions and/or other referrals provided by the user.

Based on the interactions users have with the application, the performance of the application can be determined. The performance of the application can be used in a variety of ways, including (but not limited to) determining the marketing budget and/or marketing techniques for promoting the application, and/or identifying portions of the application that generate value. Although the performance of an application based on completed user interactions is valuable in analyzing the application, it is often desirable to predict the future performance of the application to facilitate the analysis of the application. In several embodiments, a prediction of the future performance of the users of an application is generated and the prediction utilized to estimate the lifetime value of a user or group of users of the application. The prediction can also be used to improve user acquisition channels, select customers to target for offers and reactivation campaigns, and/or to determine the impact of changes to new and existing features of the application.

Lifetime value prediction systems in accordance with many embodiments of the invention are configured to predict the future performance of one or more applications by predicting the lifetime value of the users of the application. In a variety of embodiments, the future performance of an application is determined based on the performance of cohorts of users. In several embodiments, a cohort is a set of users of the application (potentially with specific characteristics). In certain embodiments, a cohort can be defined based upon users (potentially with specific characteristics) that installed (or activated) the application within specified a range of installation dates. In many embodiments, some or all of the cohort data can be generated based on historical user data and/or extrapolated from a portion of obtained user data.

The users within the cohort can be grouped by installation date and/or filtered via one or more filters as described below. User interaction data describing the user interactions the users have with the application and the value associated with those interactions is included within the cohort. In a variety of embodiments, the user metadata and/or the user interaction data is aggregated across the users identified in the user metadata. The user interaction data can describe various properties of the user interaction such as the date/time of the interaction, the value associated with the interaction, the portion of the application interacted with, and/or any other features of the interaction that are appropriate to the requirements of specific applications in accordance with embodiments of the invention.

Lifetime value prediction systems in accordance with a number of embodiments of the invention can calculate a predicted lifetime value for users of the application based on the present value generated by the users in one or more cohorts. In several embodiments, the value generated for each day since (and/or including) the day a user installed an application can be aggregated with respect to each user within the cohort and the aggregation used to determine the current value generated by the users. A variety of statistics can be calculated based on the current generated values for different cohorts and utilized to predict future value for other cohorts. Historical data describing the value associated with other applications can be utilized in the generation of the statistics and/or prediction of future value. In many embodiments, confidence bounds can be determined for the predicted future value. These confidence bounds define a range of potential future values that the application is likely to achieve based on the predicted future value, current information about the forecast cohort(s), historical information about other cohorts in the application, and/or the performance of other applications as described in the historical data. The predicted future value is utilized to predict the lifetime value for one or more users within the cohort over a period of time, often measured in days since installation of the application. In a number of embodiments, particular subsets of users within the cohort (such as revenue-generating users) are utilized in the determination of predicted lifetime value for the users of the application. The predicted future value for the users can be updated and refined as additional interaction data is obtained for the cohort. In several embodiments, the predicted lifetime value for the users is back-tested using the present value generated by the users; this allows for the analysis of the accuracy of the algorithms used in predicting lifetime value for the users and estimating the uncertainty around this prediction. Furthermore, additional and/or updated user metadata and/or user interaction data can be obtained and utilized to refine and update the predicted lifetime value data.

Systems and methods for predicting user lifetime value in accordance with embodiments of the invention are discussed below.

### Lifetime Value Prediction Systems

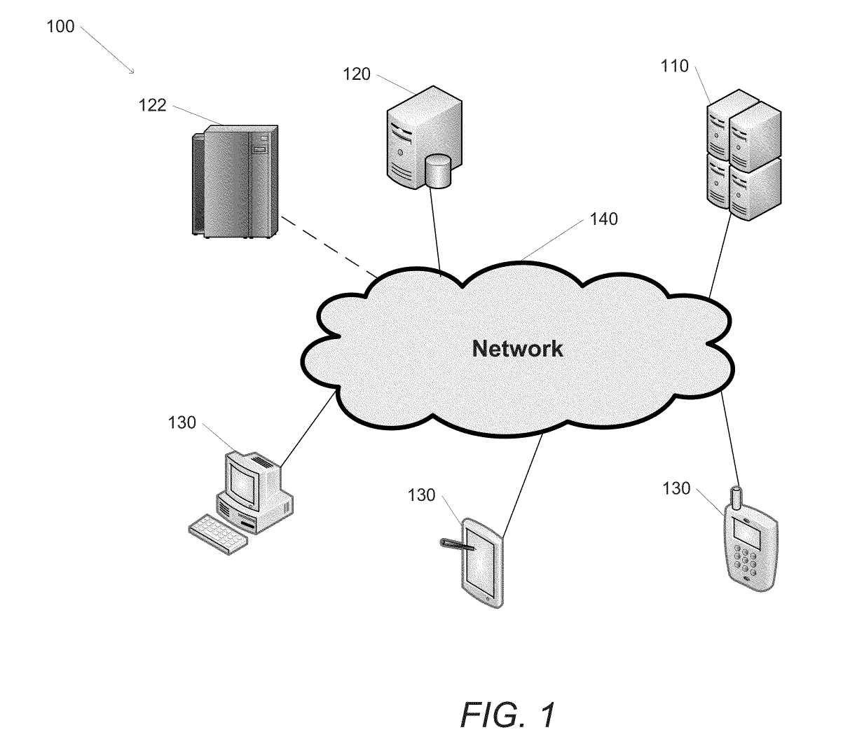

Lifetime value prediction systems in accordance with many embodiments of the invention can be configured to analyze the current value generated by users of an application and predict the lifetime value likely to be generated by those users with a particular confidence level. In this way, lifetime value prediction systems provide the ability to forecast value generated by users of the application that can be utilized to improve the performance of an application and/or drive additional users to the application. A conceptual illustration of a lifetime value prediction system in accordance with an embodiment of the invention is shown in FIG. 1. The lifetime value prediction system 100 includes a lifetime value prediction server system 110 connected to an application server system 120, one or more application devices 130, and, in a variety of embodiments, an application marketplace server system 122 via network 140. In many embodiments, the lifetime value prediction server system 110 the application server system 120, and/or the application marketplace server system 122 are implemented using a single server. In a variety of embodiments, the lifetime value prediction server system 110, the application server system 120, and/or the application marketplace server system 122 are implemented using a plurality of servers. The application devices 130 include any of a variety of network-connected devices, including personal computers, tablets, and mobile devices as appropriate to the requirements of specific applications in accordance with embodiments of the invention. Network 140 can be one or more of a variety of networks, including, but not limited to, wide-area networks, local area networks, and/or the Internet as appropriate to the requirements of specific applications in accordance with embodiments of the invention.

The application marketplace server system 122 is configured to provide an online marketplace where application devices 130 can browse and obtain applications. The application devices 130 are configured to obtain one or more applications from the application server system 120 and/or the application marketplace server system 122. The application devices 130, application marketplace server system 122, and/or the application server system 120 are configured to associate user metadata related to the application device 130. The user metadata includes the installation date of the application and/or user interaction data. In several embodiments, the user metadata includes identifying information that associates a user with one or more acquisition channels (e.g. advertising campaigns and/or online social networking messages) so that the acquisition channel utilized to encourage the user to install the application can be identified. In a variety of embodiments, the acquisition channel can be identified without information provided by the application marketplace server system 122. The application devices 130 interact with the applications; these interactions are recorded as user interaction data. The user interaction data can be recorded by the application devices 130, the application server system 120, and/or the application marketplace server system 122. In a variety of embodiments, the application server system 120 provides content that is displayed within the application and interacted with by the application devices 130. This content can include advertising content, interactive application content, online social networking content, and/or any other content as appropriate to the requirements of specific applications in accordance with embodiments of the invention.

The lifetime value prediction server system 110 is configured to obtain user metadata and the associated user interaction data from the application server system 120, the application marketplace server system 122, and/or the application devices 130. In a number of embodiments, the lifetime value prediction server system 110 is configured to create one or more cohorts based on the install date of the application as identified in the user metadata. In several embodiments, the user metadata identifies the date that the user activated the application. In many embodiments, the cohorts also include aggregations of the user metadata and/or the user interaction data. Using the user interaction data associated with the user metadata, the lifetime value prediction server system calculates the current value associated with the user interactions with the application. This value includes, but is not limited to, a monetary value (e.g. revenue generated by micro-transactions related to content within the application and/or advertising revenue generated by advertisements displayed within the application) and a virality value (e.g. value associated with the sharing of messages related to the application on one or more online social networks) as appropriate to the requirements of specific applications in accordance with embodiments of the invention. The lifetime value prediction server system is further configured to generate statistics based on the current value associated with the user interactions and calculate predicted lifetime value data for the cohorts based on the current value and the generated statistics. The predicted lifetime value data can be determined for a specified period of time (e.g. a number of days from the installation date) and/or a prediction of how much value the user will generate before the user leaves the application. In many embodiments, the lifetime value prediction server system 110 determines confidence bounds for the predicted lifetime value data describing a range of potential lifetime values falling within the predicted lifetime value data. In a number of embodiments, the lifetime value prediction server system 110 is configured to obtain additional user metadata and/or user interaction data and refine the predicted lifetime value data based on the additional data. The lifetime value prediction server system 110 can also back-test the predicted lifetime value data and/or the confidence bounds based on the existing and/or additional user metadata and user interaction data. The predicted lifetime value data can be utilized in the determination of the expected value for the software application that, as described above, can be utilized to allocate and/or improve the features of and/or money spent on the application.

Lifetime value prediction systems in accordance with embodiments of the invention are described above with respect to FIG. 1; however, any of a variety of lifetime value prediction systems can be utilized in accordance with embodiments of the invention. Systems and methods for predicting the lifetime value of users of a target application in accordance with embodiments of the invention are discussed below.

### Lifetime Value Prediction Server Systems

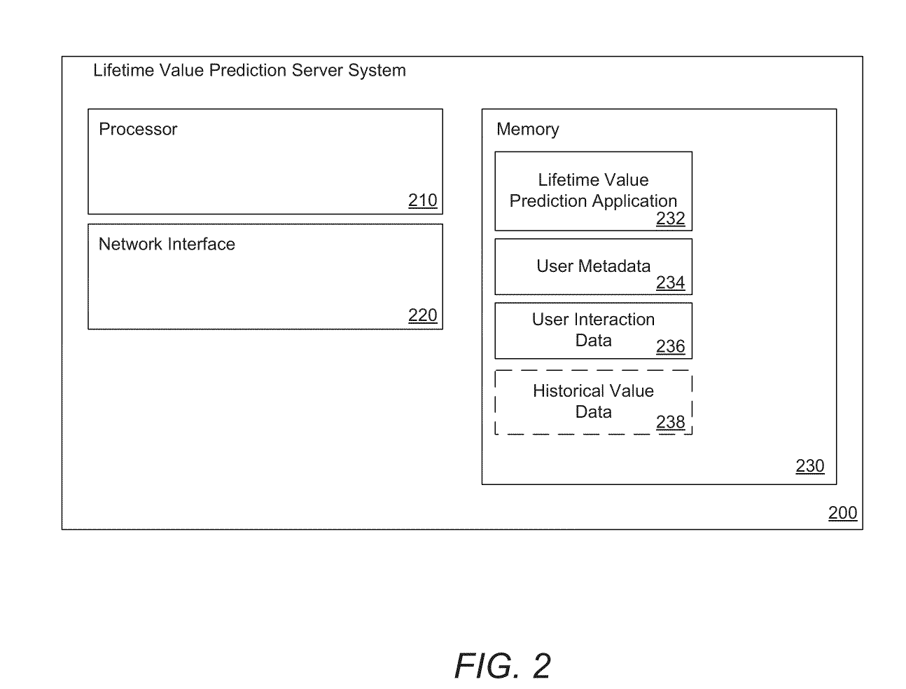

As described above, lifetime value prediction server systems are configured to analyze user interaction data for cohorts of users of an application and predict the lifetime value associated with the users of the application. A lifetime value prediction server system in accordance with an embodiment of the invention is conceptually illustrated in FIG. 2. The lifetime value prediction server system 200 includes a processor 210 in communication with a memory 230. The lifetime value prediction server system 200 can also include a network interface 220 configured to send and receive data over a network connection. In a number of embodiments, the network interface 220 is in communication with the processor 210 and/or memory 230. In several embodiments, the memory 230 is any form of storage configured to store a variety of data, including, but not limited to, a lifetime value prediction application 232, user metadata 234, user interaction data 236, and, in a number of embodiments, historical value data 238. In many embodiments, user metadata 234, user interaction data 236, and/or historical value data 238 are stored using an external server system and received by the lifetime value prediction server system 200 using the network interface 220. External server systems in accordance with a variety of embodiments include, but are not limited to, application marketplace server systems, application server systems, and other distributed storage services as appropriate to the requirements of specific applications in accordance with embodiments of the invention.

The lifetime value prediction application 232 configures processor 210 to perform a lifetime value prediction process. The lifetime value prediction process includes obtaining user metadata 234 and user interaction data 236. In a number of embodiments, the lifetime value prediction process includes identifying one or more acquisition channels associated with the user and the installation of the application as described in the user metadata 234. The lifetime value prediction process further includes generating cohorts based on the user metadata 234 and the user interaction data 236, determining the current value generated by the user interactions, and generating statistics based the user metadata 234 and the user interaction metadata 236. Techniques for generating the cohorts and statistics are described in more detail below. A set of predicted lifetime value data for the users of the application is determined with respect to a specified period of time for the future lifetime of the application. In a number of embodiments, historical value data 238 is utilized in predicting lifetime value data. The historical value data 238 includes the value data associated with a set of historical user interactions for one or more applications. In several embodiments, the users identified in the historical value data 238 share characteristics that are similar to the users identified within the cohort. In a number of embodiments, the historical value data 238 includes historical user data identifying a user associated with the historical user interactions and/or an installation date associated with the historical user and one or more historical applications. Other historical data can be included in the historical value data 238 as appropriate to the requirements of specific applications in accordance with embodiments of the invention. In several embodiments, the lifetime value prediction process includes determining confidence bounds for the predicted lifetime value data. Techniques for determining these confidence bounds that can be utilized in accordance with embodiments of the invention are discussed in more detail below. In a number of embodiments, the lifetime value prediction process includes obtaining additional user metadata and/or user interaction data and refining the predicted lifetime value data based on the additional data. The lifetime value prediction process can also include back-testing the predicted lifetime value data and/or the confidence bounds based on the existing and/or additional user metadata and user interaction data. Additionally, the lifetime value prediction process can include obtaining additional and/or updated user metadata and/or user interaction data and refining and/or updating the predicted lifetime value data.

Although a specific architecture for a lifetime value prediction server system in accordance with embodiments of the invention are described above with respect to FIG. 2, any of a variety of architectures, including those which store data or applications on disk or some other form of storage and are loaded into memory at runtime and systems that are distributed across multiple physical servers, can also be utilized in accordance with embodiments of the invention. In a variety of embodiments, the memory includes circuitry such as, but not limited to, memory cells constructed using transistors, that are configured to store instructions. Similarly, the processor can include logic gates formed from transistors (or any other device) that are configured to dynamically perform actions based on the instructions stored in the memory. In several embodiments, the instructions are embodied in a configuration of logic gates within the processor to implement and/or perform actions described by the instructions. In this way, the systems and methods described herein can be performed utilizing both general-purpose computing hardware and by single-purpose devices. Processes for generating cohorts and predicting lifetime values for the users in accordance with embodiments of the invention are discussed below.

### Generating Cohorts

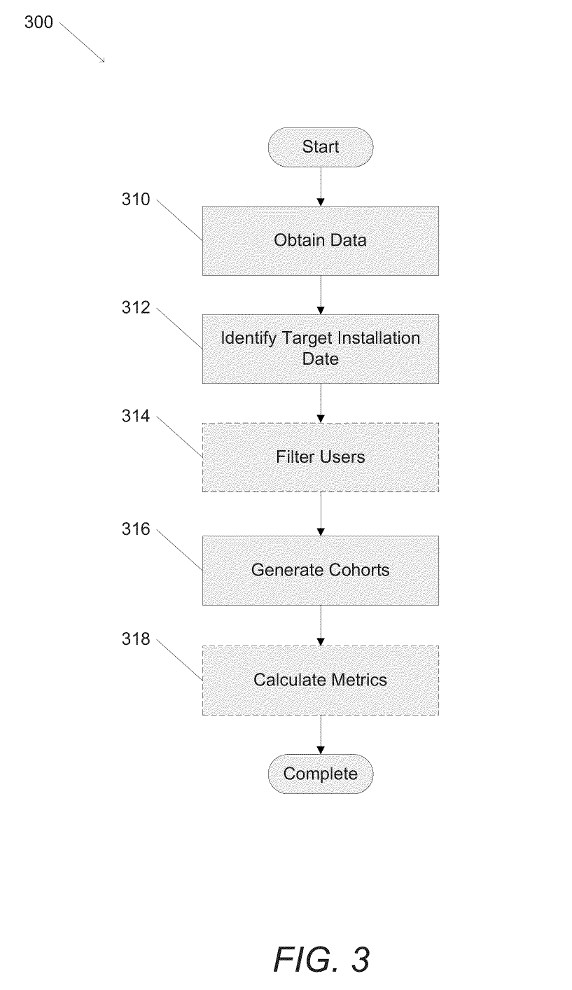

A cohort is a group of users. The cohorts allow for the efficient analysis of user interaction data to identify value associated with the application and prediction of future value related to the application. Lifetime value prediction server systems in accordance with many embodiments of the invention are configured to generate cohorts from user metadata and user interaction data. The cohort can include data aggregated across the users identified in the user metadata. A process for generating cohorts in accordance with an embodiment of the invention is conceptually illustrated in FIG. 3. The process 300 includes obtaining (310) data and identifying (312) a target installation date. In a variety of embodiments, users are filtered (314). Cohorts are generated (316) and, in many embodiments, metrics are calculated (318).

In a number of embodiments, the obtained (310) data includes user metadata and user interaction data captured for users of an application. The data can be obtained (310) from a variety of sources in accordance with embodiments of the invention including, but not limited to, application marketplace server systems, application server systems, and/or application devices as described above. In several embodiments, one or more target installation dates are identified (312) based on the installation dates identified within the user metadata. The users can be filtered (314) using a variety of filtering criteria as appropriate to the requirements of specific applications in accordance with embodiments of the invention including, but not limited to, an advertising campaign associated with driving the users to the application, categories associated with the users, content available within the application that has been interacted with by the user(s), demographic information (e.g. age, gender, location, or any other demographic information, revenue generated by the user, online social networking activity generated by the user related to the application, and/or any other value generated by the user. In a variety of embodiments, cohorts are generated (316) by grouping users within the obtained (310) user metadata based on the date the user installed the application. In many embodiments, the users within a cohort are aligned so that the installation day for all of the users is the same relative day (e.g. the installation day is the first day for every user irrespective of the actual installation date). In this way, the relative daily value attributed to a user can be aggregated and processed irrespective of differences in the installation date of the application. In a variety of embodiments, cohorts are generated (316) with users having a value associated with the user exceeding a value threshold; this threshold can be pre-determined and/or determined dynamically. This allows for users having (or lacking) value-generating user interactions to be excluded from the aggregation and/or processing of the user interaction data. The calculated (318) metrics include, but are not limited to, value generated by the users with respect to the application, the lifetime of a user with respect to the application, the location of the users, the acquisition source associated with the installation of the application by the user, and any other metrics as appropriate to the requirements of specific applications in accordance with embodiments of the invention.

Specific processes for generating cohorts are discussed above with respect to FIG. 3; however, any of a variety of processes, including those that generate cohorts across multiple applications and those that track follow on value generated by the users migrating between applications, can be performed in accordance with embodiments of the invention. Processes for predicting lifetime user value in accordance with embodiments of the invention is described below.

### Predicting User Lifetime Value

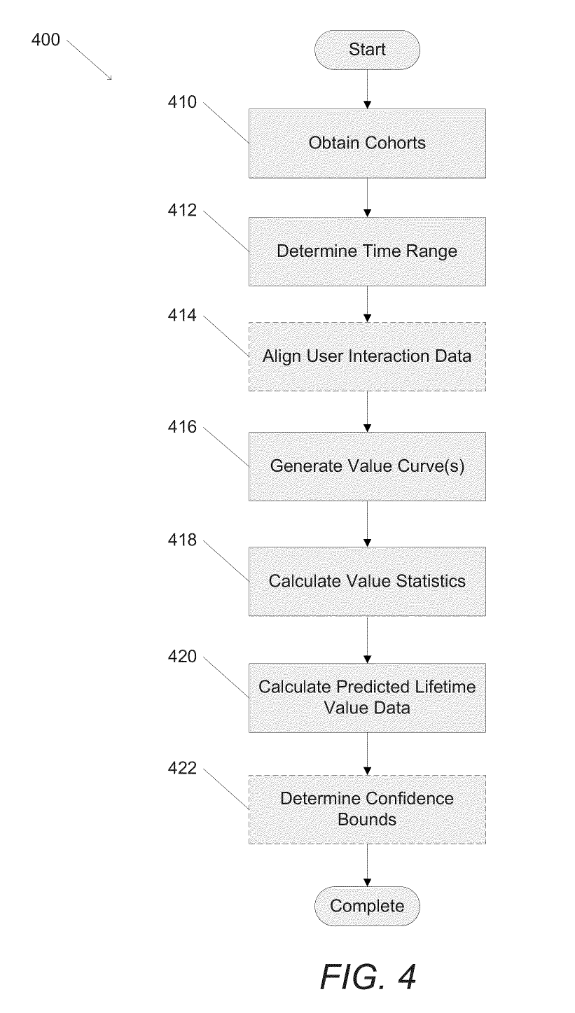

As described above, the lifetime value for users of an application can be utilized to track the effectiveness of marketing campaigns and/or features of the application in generating value. By predicting the user lifetime value for an application, the resources needed to develop and promote an application can be effectively allocated based on the anticipated value generated by the application. Lifetime value prediction server systems in accordance with embodiments of the invention are configured to predict the user lifetime value for cohorts of users of an application. A process for predicting user lifetime value in accordance with an embodiment of the invention is conceptually illustrated in FIG. 4. The process 400 includes obtaining (410) cohorts. A time range is determined (412). In several embodiments, interaction data is aligned (414). A value curve is generated (416) and value statistics are calculated (418). Lifetime value data is calculated (420) and, in a number of embodiments, confidence bounds are determined (422).

In a variety of embodiments, cohorts are obtained (410) using techniques similar to those described above. The determined (412) time range can be a number of days since the installation of the application, the anticipated lifetime of the application, or any other range of time as appropriate to the requirements of specific applications in accordance with embodiments of the invention. In many embodiments, the user interaction data in the obtained (410) cohorts can be aligned (414) utilizing techniques described above. Value curves can be generated (416) for one or more cohorts. In several embodiments of the invention, a value curve is generated (416) by accumulating the value associated with the user interactions contained within the cohort for each day (including the installation day) that users have installed and/or interacted with the application. In a number of embodiments, a value curve only includes the days that every user within the cohort has had the application installed. Other threshold values (such as a number of users exceeding a threshold value) for including user interactions within the value curve can be utilized as appropriate to the requirements of specific applications in accordance with embodiments of the invention. For example, if a cohort has User A that has installed the application for 5 days and User B that has installed the application for 3 days at the time of prediction, the generated (416) value curve would include data points for three days. In this way, the generated (416) value curve includes data points that cover every user within the cohort. Other value curves, including those with data points that only have partial coverage of the users within the cohort, can be utilized as appropriate. In many embodiments, the calculated (418) value statistics include the mean, variance, and/or standard deviation associated with the generated (416) value curves, although any statistical measures of the generated (416) value curves can be utilized. The calculated (418) value statistics can be between users of a single cohort and/or between users of multiple cohorts. In a number of embodiments, the calculated (418) value statistics are between one or more cohorts and historical value data.

The calculated (420) predicted lifetime value data includes a predicted value associated with user interactions anticipated to be performed by one or more users within the obtained (410) cohorts for one or more days in the determined (412) time range. In many embodiments, the calculated (420) predicted lifetime value data includes estimating value data for users within a cohort that do not have value data associated with a particular day while other users within the cohort do have value data associated with the day. The predicted lifetime value data can, although does not have to, include the predicted user interactions and/or identify the user within the cohort(s) performing the interactions. In a variety of embodiments, the predicted lifetime value data includes a portion of actual data and a portion predicted data based upon the number of days of user interaction data provided within the cohort. In several embodiments the predicted lifetime value data is calculated (420) based on the generated (416) value curves and/or the calculated (418) value statistics for the determined (412) time range. In a variety of embodiments, the predicted lifetime value data is calculated (420) based on an expected value breakdown and/or historical value data. For example, if there exists 10 days of cohort data, the determined time range is 10 days (20 days total), and historical value data indicates that the application should experience 40% of its value in the first 10 days and 60% of its value over the next 10 days, the calculated (420) predicted value would be selected such that the generated (416) value curve includes approximately 40% of the total predicted lifetime value. The shape of the predicted (420) lifetime value data can be based on a variety of extrapolation techniques, such as linear extrapolation, polynomial extrapolation, the shape of the generated (416) value curve, and/or historical data. Any extrapolation technique not specifically described can also be utilized as appropriate to the requirements of specific applications in accordance with embodiments of the invention. In many embodiments, confidence bounds are determined (422) for the calculated (420) predicted lifetime value data based on the calculated (418) value statistics. Any of a variety of confidence interval techniques, such as sampling from a distribution and/or from historical value data, can be utilized as appropriate to the requirements of specific applications in accordance with embodiments of the invention. The range sampled from the distribution and/or historical value data corresponds to the desired accuracy expressed in the determined (422) confidence interval.

In a number of embodiments, the generated (420) predicted lifetime value data is generated by

$${S}_{p}^{j} = {S}_{d}^{j} {〈 \frac{{S}_{p}^{c}}{{S}_{d}^{c}} 〉}_{c}$$

where Sₚ^{j} is the cumulative spending for cohort j through day p and S_{d}^{c} is the cumulative spending for training cohort(s) c through day d. In a variety of embodiments, cohort c includes historical value data. This can be reformulated as

$${S}_{p}^{j} = {S}_{d}^{j} + {M}_{d}^{j} {T}_{d}^{j} {〈 \frac{{S}_{p}^{c} - {S}_{d}^{c}}{{S}_{d}^{c}} 〉}_{c} \qquad ( 1 )$$

where M_{d}^{j} is the average value per user interaction and T_{d}^{j} is the cumulative number of user interactions for the first d days for cohort j. Given (either by calculation or by extrapolation from current value data and/or historical value data)
P[Sₚ^{j}]
   the confidence interval can be determined (422) for equation (1) by taking S_{d}^{j}, M_{d}^{j}, T_{d}^{j}, and/or Sₚ^{c}−S_{d}^{c}/S_{d}^{c} as a constant, a gamma distribution, a Poisson distribution, and/or a log-normal distribution. Other distributions can be utilized as appropriate to the requirements of specific applications in accordance with embodiments of the invention. The expected value of M_{d}^{j} can be determined by

$$E [ {M}_{d}^{j} ] \approx {μ}_{d}^{j} = \frac{{S}_{d}^{j}}{{T}_{d}^{j}}$$

$$V [ {M}_{d}^{j} ] \approx {{σ}^{2}}_{d}^{j} = \frac{{\sum }_{i = 1}^{N} {( {M}_{i}^{j} - {μ}_{d}^{j} )}^{2}}{N - 1}$$

$$and$$

$$V [ {M}_{d}^{j} ] = \frac{E [ {\sum }_{k = 1}^{d} {( \frac{{\tilde{S}}_{k}^{j}}{{\tilde{T}}_{k}^{j}} - \frac{{S}_{d}^{j}}{{T}_{d}^{j}} )}^{2} ]}{{\sum }_{k = 1}^{d} \frac{N - {\tilde{T}}_{k}^{j}}{N {\tilde{T}}_{k}^{j}}}$$

where N is the total time range over which the predicted lifetime value data is calculated (420). In a variety of embodiments, the confidence interval is determined (422) by generating a number of distributions with the appropriate statistical distribution and iteratively determining the confidence level using the generated distributions.

### Displaying Predicted Lifetime Value Data

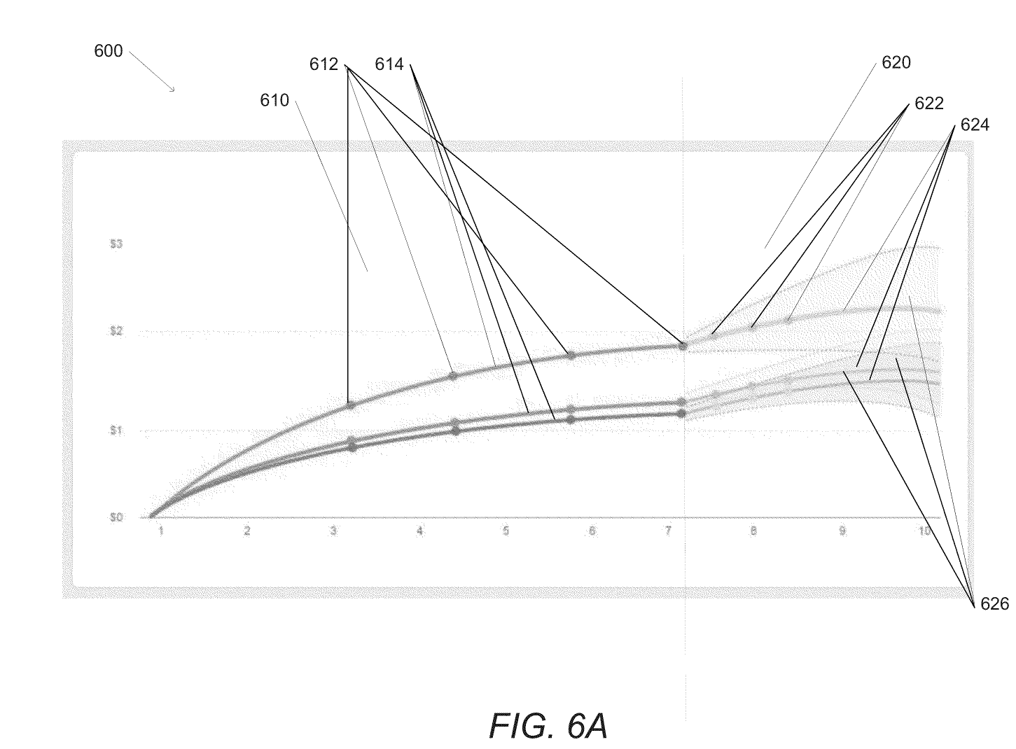

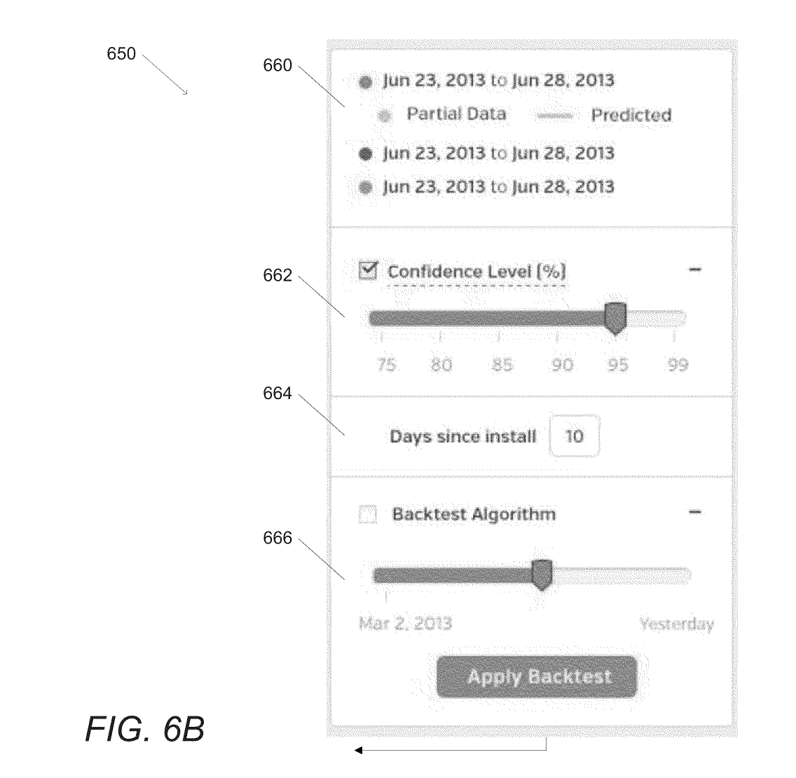

Turning now to FIG. 6A, an exemplary user interface for displaying predicted lifetime value data in accordance with an embodiment of the invention is conceptually illustrated. The predicted lifetime value curve 600 includes a known portion 610 of the predicted lifetime value curve having generated value curves 614 with value data 612 taken from a set of cohorts. The set of cohorts contains value data for approximately eight days, although it should be noted that only seven days of value data are covered by all users described within the set of cohorts. The predicted lifetime value curve 600 further includes a calculated predicted lifetime value portion 620 having predicted value curves 624 and corresponding confidence bounds 626. The predicted value curves 624 include a set of points, a portion 622 of which are based on known spending data within the set of cohorts. The portion of the predicted value curves 624 include predicted lifetime value data calculated utilizing processes described above.

Turning now to FIG. 6B, an exemplary user interface for configuring the predicted user lifetime value data is shown. The configuration panel 650 includes a legend 660 describing the properties (e.g. known data, partial data, and predicted data) contained within the predicted lifetime value curve 600. Confidence level control 662 provides an interface for adjusting the confidence interval 626 for the predicted value curves 624. Time period control 664 includes an interface to input a determined time range that the predicted lifetime value curve (and the corresponding sub-curves known portion 610 and predicted lifetime value portion 620) will describe. The refinement portion 666 provides a control for measuring the confidence of the predicted lifetime value data 620. Techniques for back-testing the predicted lifetime value data to refine and/or measure the performance of the calculated predicted lifetime value data are described in more detail below.

Although processes for predicting lifetime value for users are discussed above with respect to FIG. 4 and conceptually illustrated in FIGS. 6A and 6B, any of a variety of interfaces and processes, including those that calculate predicted user value using agent-based models or alternative techniques not described above, can be performed in accordance with embodiments of the invention. Processes for back-testing and refining predicted lifetime value data in accordance with embodiments of the invention are discussed below.

### Back-Testing and Refining Predicted Lifetime Value Data

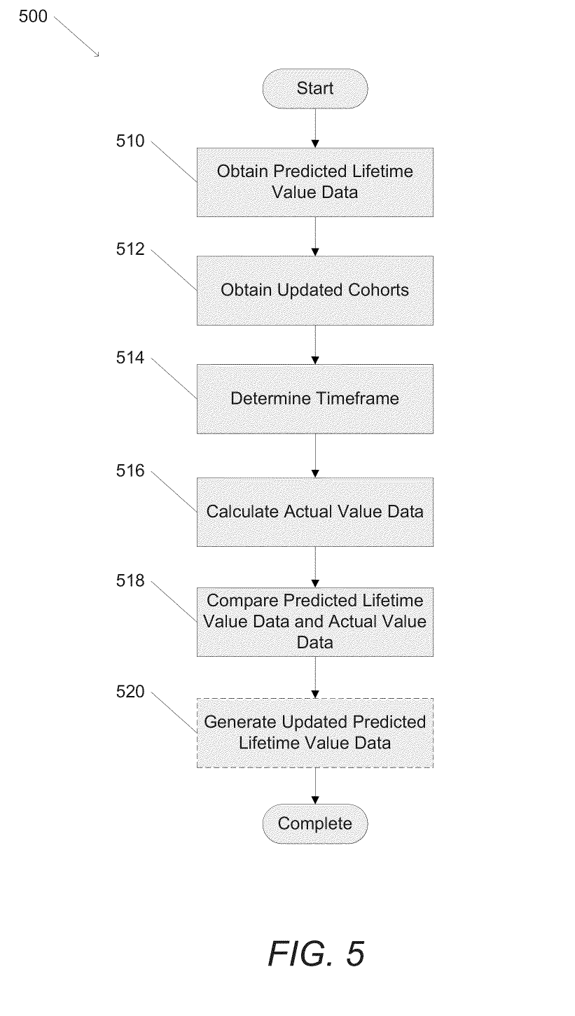

The accuracy of, and by extension the confidence in, predicted lifetime value data for users of a particular application can be measured by testing the predictions against known value data for the application. Alternatively, additional data can be collected and used to later verify the accuracy of the predicted lifetime value data. Additionally, as additional user interaction data is gathered for the cohorts utilized to calculate the predicted lifetime value data, the prediction can be updated to better reflect the realities associated with the application. Lifetime value prediction server systems in accordance with a number of embodiments of the invention are configured to back-test and/or refine predicted lifetime value data. A process for back-testing and refining predicted lifetime value data in accordance with an embodiment of the invention is conceptually illustrated in FIG. 5. The process 500 includes obtaining (510) predicted lifetime value data. Updated cohorts are obtained (512). A timeframe are determined (514) and actual value data is calculated (516). The predicted value data and the actual value data are compared (518) and, in many embodiments, updated predicted lifetime value data is generated (520).

In many embodiments, predicted lifetime value data is obtained (510) utilizing processes similar to those described above. Updated cohorts include user interaction data for an application that was not utilized (e.g. not available) when the obtained (510) predicted lifetime values were calculated. In several embodiments, the updated cohorts include updated and/or new user metadata and/or user interaction data describing additional interactions performed by existing users and/or new users of the application. In a number of embodiments, updated cohorts are obtained (512) and timeframes are determined (514) utilizing processes similar to those described above. The determined (514) timeframe can be smaller than, equal to, or greater than the timeframe utilized in the calculation of the obtained (510) predicted lifetime values. Actual value data is calculated (516) based on the updated cohorts; processes similar to those described above can be utilized to perform the calculations (516) in accordance with embodiments of the invention. A variety of techniques can be utilized to compare (518) the obtained (510) predicted lifetime value data to the calculated (516) actual value data corresponding to the predictions. These techniques include, but are not limited to, comparing the difference (e.g. delta) between the predicted and actual values, comparing the probabilities between obtaining the predicted value and the actual value on the predicted day, and/or any other measurement technique as appropriate to the requirements of specific applications in accordance with embodiments of the invention. The comparison (518) of the predicted lifetime value data and the actual value data can be utilized to determine the confidence in and/or the accuracy of the predicted lifetime value data. In several embodiments, processes similar to those described above are utilized to generate (520) updated predicted lifetime value data based on the obtained (512) updated cohorts.

Specific processes for the back-testing of predicted lifetime value data are discussed above with respect to FIG. 5; however, any of a variety of processes, including those that perform back-testing by utilizing a portion of days described within a cohort and comparing the predicted lifetime value data against the remaining days described within the cohort, can be performed in accordance with embodiments of the invention. Techniques for augmenting cohort data in accordance with embodiments of the invention is described in more detail below.

### Augmenting Cohorts

It is often desirable to have as much user interaction data as possible in order to make predictions regarding the lifetime value of cohorts of the users. However, this can lead to an undesirable amount of latency between the beginning of tracking user interaction data and the calculation of predicted lifetime value. In many embodiments, additional user interaction data and/or cohorts can be generated and used to supplement the existing user interaction data. In this way, lifetime values can be predicted without having to wait for the full set of user interaction data. Additionally, the supplemental data can be refined and/or replaced as additional user interaction data is obtained. In a number of embodiments, the user interaction data falls within a particular statistical distribution. This distribution can be utilized in the generation of supplemental data. This also has the additional benefit of modeling the noise and/or uncertainty in the received data, thereby allowing for the generation of supplemental data that more accurately reflects the observed performance. Additionally, historical data can also be utilized in the generation of supplemental data. This historical data can be taken from a global set of historical interaction data and/or from a portion of historical data that has been identified as related to the particular application/users that are the subject of the predicted lifetime value analysis.

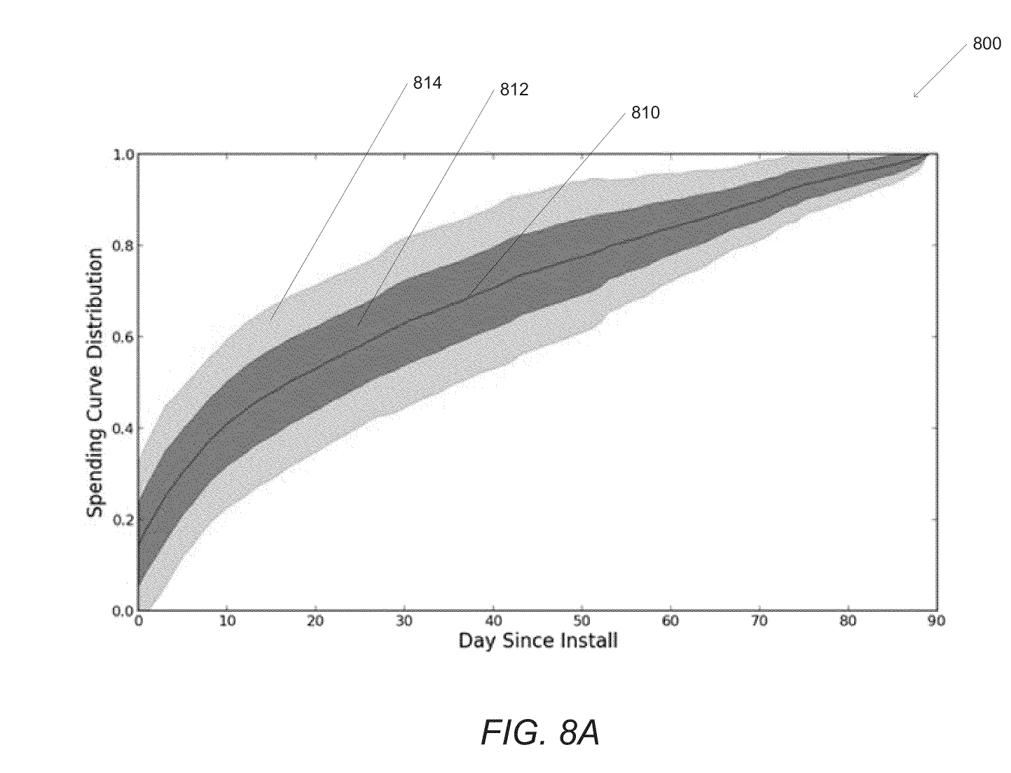

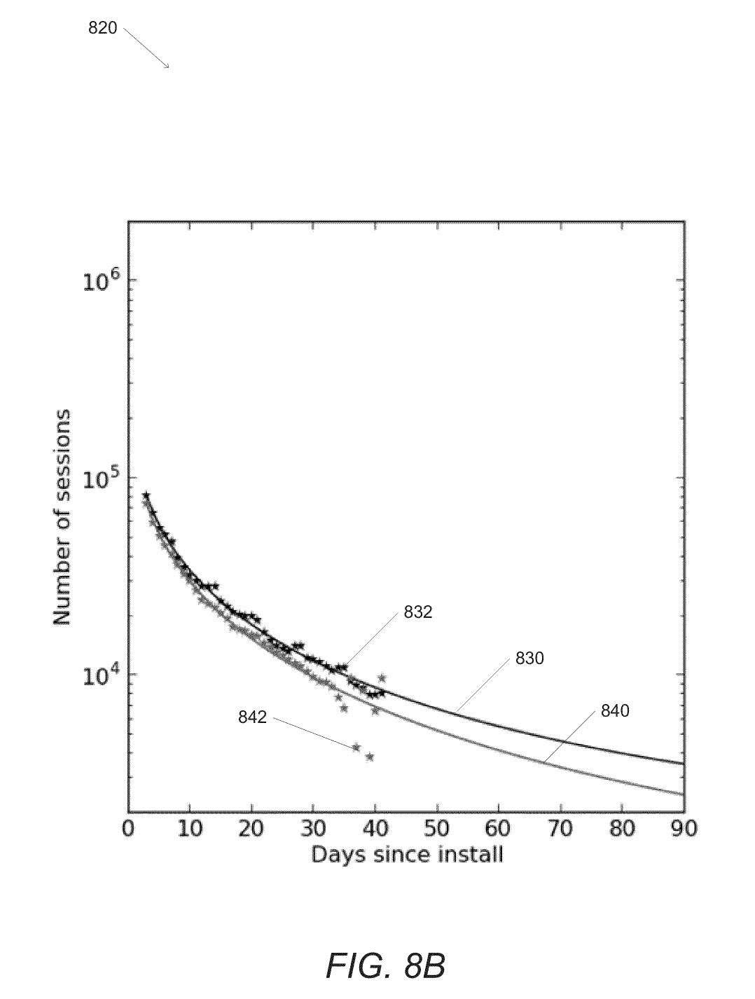

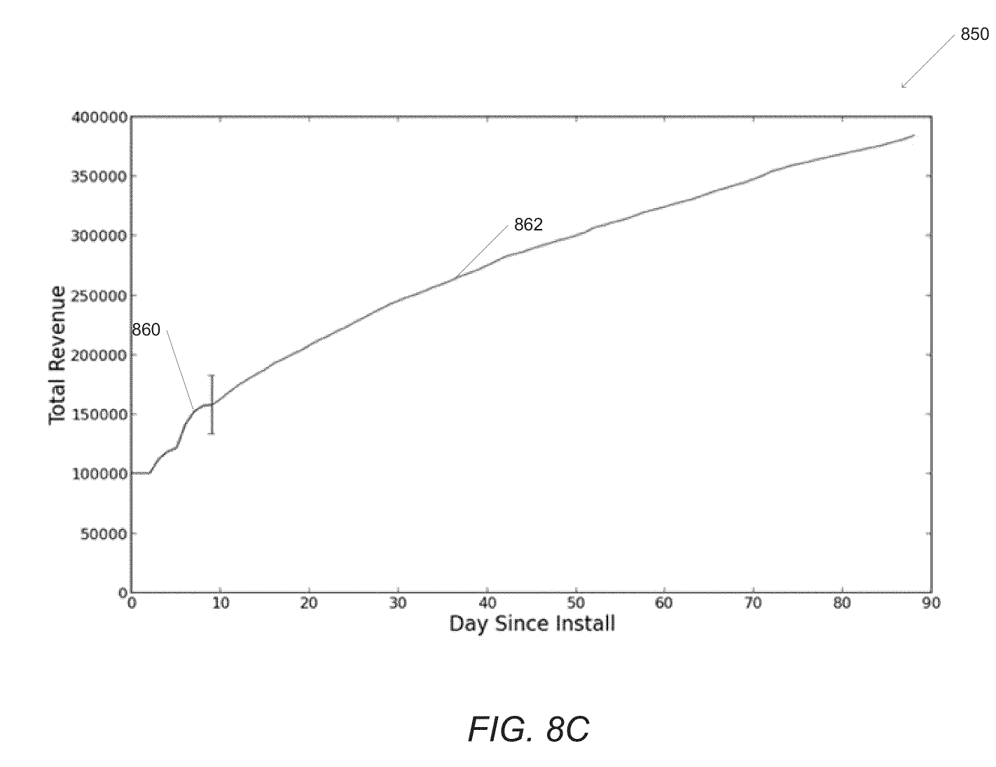

In a variety of embodiments, historical cohort and/or lifetime value data can be utilized in the calculation of supplemental user interaction data and/or cohorts. Turning now to FIG. 8A, a conceptual illustration of historical cohorts in accordance with an embodiment of the invention is shown. The historical data 800 includes historical cohort data 810 along with predicted lifetime spending values 812 and 814. In several embodiments, additional user interaction data and/or cohorts can be extrapolated from previously obtained user interaction data and/or cohorts. Turning now to FIG. 8B, a conceptual illustration of extrapolated cohorts in accordance with an embodiment of the invention is shown. The extrapolated data 820 includes a first extrapolated cohort 830 based on a first set of user interaction data 832 along with a second extrapolated cohort 840 based on a second set of user interaction data 842. Any of a variety of statistical techniques, such as a best-fit, worst-fit, or any other linear or non-linear regression, can be utilized as appropriate to the requirements of specific applications of embodiments of the invention. In a variety of embodiments, the extrapolated data is calculated by measuring the mean and variance from one or more days in the original data and sampling additional values from the measured distribution. Once the extrapolated cohort data is calculated, the extrapolated data can be combined with the observed data and utilized to predict the lifetime value utilizing techniques similar to those described above. Turning now to FIG. 8C, a conceptual illustration of the predicted lifetime value for a set of cohorts including supplemental cohort data is shown. The predicted lifetime value graph 850 includes the total revenue for a set of obtained cohorts 860 along with the predicted total revenue for the obtained cohorts along with supplemental data 862.

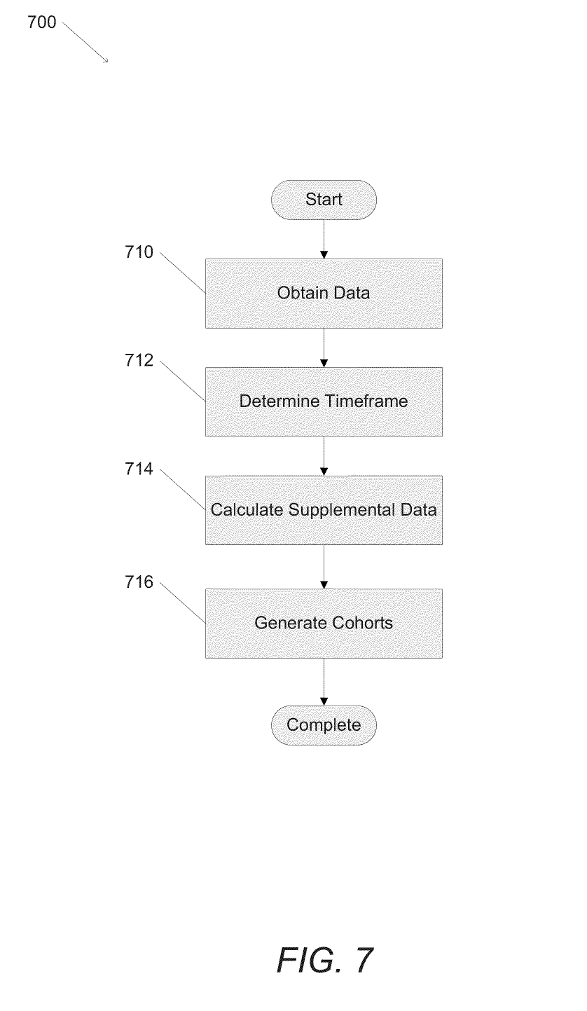

A process for augmenting cohorts in accordance with an embodiment of the invention is conceptually illustrated in FIG. 7. The process 700 includes obtaining (710) data and determining (712) timeframes. Supplemental data is calculated (714) and cohorts are generated (716). Specific process for augmenting cohorts in accordance with embodiments of the invention are described above; however, it should be noted that a variety of techniques, including those that estimate user and cohort activity utilizing alternative statistical techniques to those described above, can be utilized as appropriate to the requirements of specific applications of the invention. By way of example only, in many embodiments 90 days of user interaction data is utilized to generate predicted lifetime values for the users. After 10 days of observed user interaction data, an additional 80 days of user interaction data can be generated based on the observed user interaction data and/or historical user interaction data. This results in a total of 90 days of user interaction data that can be utilized to generated predicted lifetime value data along with confidence bounds in the predicted data utilizing techniques similar to those described above.

Although the present invention has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A lifetime value prediction server system, comprising:
a processor; and
a memory configured to store a lifetime value prediction application;
wherein the lifetime value prediction application directs the processor to:
obtain a set of user interaction data comprising:
interaction data describing interactions with a target application;
timestamp data describing when the interactions occurred; and
value data associated with a user interaction with the target application for users having the same installation date and a measure of the number of days since the installation of the target application;
group the set of user interaction data into cohorts, where the user interaction data within a cohort occurs on a particular day;
calculate a set of known spending values based on the cohorts, where the set of known spending values includes a total spending value for the cohort for the usage data for each day having aggregated user interaction data within the cohort;
determine a set of predicted spending values based on the set of known spending values, where the size of the set of predicted spending values is based on a desired number of days since the installation of the target application;
determine a set of predicted spending confidence values for each predicted spending value in the set of predicted spending values based on the set of known spending values; and
calculate a set of predicted lifetime value data based on the set of predicted spending values and the set of predicted spending confidence values.

2. The system of claim 1, wherein the cohorts are aligned based on the installation of the target application.

3. The system of claim 2, wherein the set of predicted spending values is determined on days when each cohort has user interaction data for those days.

4. The system of claim 2, wherein the set of predicted spending values is determined on days when a portion of the cohorts has user interaction data for those days.

5. The system of claim 1, wherein the cohorts are aligned based on a set of days.

6. The system of claim 1, wherein the lifetime value prediction application further directs the processor to:
obtain historical user interaction data comprising:
historical interaction data describing interactions with a target application;
historical timestamp data describing when the interactions occurred; and
historical value data associated with a user interaction with the target application for users having the same installation date and a measure of the number of days since the installation of the target application; and
calculate a set of predicted lifetime value data based on the set of predicted spending values, the set of predicted spending confidence values, and the historical user interaction data.

7. The system of claim 6, wherein the lifetime value prediction application further directs the processor to:
group the historical user interaction data into historical cohorts; and
combine the historical cohorts with the cohorts.

8. The system of claim 1, wherein the predicted spending confidence values are based on a threshold confidence interval.

9. The system of claim 8, wherein the threshold confidence interval is pre-determined.

10. The system of claim 8, wherein the confidence interval is determined by:
generating a number of statistical distributions with the appropriate statistical distribution; and
iteratively determining the confidence level using the generated distributions.

11. The system of claim 1, wherein the cohorts are selected based on the value data of the user interaction data within the cohorts.

12. The system of claim 1, wherein the lifetime value prediction application further directs the processor to:
filter the user interaction data; and
group the set of user interaction data into cohorts using the filtered user interaction data.

13. The system of claim 12, wherein the user interaction data is filtered based on the timestamp data.

14. The system of claim 12, wherein the user interaction data is filtered based on the value data.

15. The system of claim 1, wherein the value data comprises monetary spending within the target application

16. The system of claim 1, wherein the value data comprises online social networking messages obtained by the target application.

17. The system of claim 1, wherein the value data comprises interactions with advertising data displayed within the target application.

18. The system of claim 1, wherein the lifetime value prediction application further directs the processor to:
obtain additional user interaction data;
group user interaction data into cohorts including the additional user interaction data;
compute updated known spending values based on the cohorts and the additional user interaction data; and
refine the calculated set of predicted lifetime value data based on the updated known spending values.

19. The system of claim 18, wherein the lifetime value prediction application further directs the processor to measure performance of the calculated predicted lifetime value data based on the updated known spending values.

20. A method for predicting user lifetime value data, comprising:
obtaining a set of user interaction data using a lifetime value prediction server system, the user interaction data comprising:
interaction data describing interactions with a target application;
timestamp data describing when the interactions occurred; and
value data associated with a user interaction with the target application for users having the same installation date and a measure of the number of days since the installation of the target application;
grouping the set of user interaction data into cohorts using the lifetime value prediction server system, where the user interaction data within a cohort occurs on a particular day;
calculating a set of known spending values based on the cohorts using the lifetime value prediction server system, where the set of known spending values includes a total spending value for the cohort for the usage data for each day having aggregated user interaction data within the cohort;
determining a set of predicted spending values based on the set of known spending values using the lifetime value prediction server system, where the size of the set of predicted spending values is based on a desired number of days since the installation of the target application;
determining a set of predicted spending confidence values for each predicted spending value in the set of predicted spending values based on the set of known spending values using the lifetime value prediction server system; and
calculating a set of predicted lifetime value data based on the set of predicted spending values and the set of predicted spending confidence values using the lifetime value prediction server system.

21. A non-transitory machine readable medium containing processor instructions, where execution of the instructions by a processor causes the processor to perform a process comprising:
obtaining a set of user interaction data, the user interaction data comprising:
interaction data describing interactions with a target application;
timestamp data describing when the interactions occurred; and
value data associated with a user interaction with the target application for users having the same installation date and a measure of the number of days since the installation of the target application;
grouping the set of user interaction data into cohorts, where the user interaction data within a cohort occurs on a particular day;
calculating a set of known spending values based on the cohorts, where the set of known spending values includes a total spending value for the cohort for the usage data for each day having aggregated user interaction data within the cohort;
determining a set of predicted spending values based on the set of known spending values, where the size of the set of predicted spending values is based on a desired number of days since the installation of the target application;
determining a set of predicted spending confidence values for each predicted spending value in the set of predicted spending values based on the set of known spending values; and
calculating a set of predicted lifetime value data based on the set of predicted spending values and the set of predicted spending confidence values.
